(19) United States
(12) Patent Application Publication
(10) Pub. No.: US 2017/0329460 A1
(43) Pub. Date: Nov. 16, 2017

(54) METHOD AND DEVICE FOR INPUTTING KOREAN CHARACTERS BASED ON MOTION OF FINGERS OF USER

(71) Applicant: SAMSUNG ELECTRONICS CO., LTD., Suwon-si, Gyeonggi-do (KR)

(72) Inventors: Su-Jung BAE, Yongin-si, Gyeonggi-do (KR); Hye-sun KIM, Yongin-si, Gyeonggi-do (KR); Moon-sik JEONG, Seongnam-si, Gyeonggi-do (KR); Sung-do CHOI, Suwon-si, Gyeonggi-do (KR); Hyun-soo CHOI, Seoul (KR)

(21) Appl. No.: 15/528,304

(22) PCT Filed: Oct. 21, 2015
(86) PCT No.: PCT/KR2015/011132

§ 371 Date: May 19, 2017

(30) Foreign Application Priority Data
Nov. 20, 2014 (KR) 10-2014-0162603

(51) Int. Cl. G06F 3/042; G06F 3/01; G06F 3/0484; G06F 3/0489

(52) U.S. Cl. CPC G06F 3/0426; G06F 3/04842; G06F 3/017; G06F 3/0489

(57) ABSTRACT

Provided are a method of receiving a Korean input by using an electronic apparatus and an apparatus. The method of inputting Korean, performed by using an electronic apparatus includes: displaying consonant buttons for inputting Korean consonants on a screen of the electronic apparatus; identifying a user's fingers; as a motion of a first finger is sensed among the user's fingers, selecting a consonant button corresponding to a location of the first finger; as the consonant button is selected, displaying vowel buttons corresponding to second, third, and fourth fingers among the user's fingers and being used to input Korean vowels on the screen of the electronic apparatus; and as a motion of at least one finger of the second, third, and fourth fingers is sensed, selecting at least one vowel button corresponding to the at least one finger.

### TECHNICAL FIELD

The present disclosure relates to a method and an apparatus for inputting Korean based on motions of a user's fingers.

### BACKGROUND ART

As digital environments have been developed, applications requiring a text (character) input function such as searching, tweeting, e-mailing, etc. are widely utilized in apparatuses such as data broadcasting, Internet Protocol televisions (IPTVs), smart TVs, etc.

However, unlike users' expectations with respect to a text input method, a text input method using a remote controller is very difficult and inefficient, and a keyboard input method has a limited usage since there is no space for a keyboard in a living room that is a main space for watching TV.

### DETAILED DESCRIPTION OF THE INVENTION

### Technical Problem

There is a need for an exact and convenient text input apparatus capable of replacing a remote controller or a keyboard, etc.

### Technical Solution

According to some embodiments of the present disclosure, a method of inputting Korean, performed by using an electronic apparatus includes displaying consonant buttons for inputting Korean consonants on a screen of the electronic apparatus; identifying a user's fingers; as a motion of a first finger is sensed among the user's fingers, selecting a consonant button corresponding to a location of the first finger; as the consonant button is selected, displaying vowel buttons corresponding to second, third, and fourth fingers among the user's fingers and being used to input Korean vowels on the screen of the electronic apparatus; and as a motion of at least one finger of the second, third, and fourth fingers is sensed, selecting at least one vowel button corresponding to the at least one finger.

### DESCRIPTION OF THE DRAWINGS

FIG. 1 is a schematic diagram for explaining a method of inputting Korean by using an electronic apparatus, according to some embodiments of the present application.

FIG. 2 is a diagram for explaining a method of inputting Korean according to an embodiment of the present disclosure.

FIGS. 3A and 3B illustrate examples in which an electronic apparatus displays consonant buttons for inputting Korean consonants.

FIGS. 4A and 4B illustrate examples in which an electronic apparatus displays Korean vowel buttons for inputting Korean vowels.

FIG. 5 is a table showing an example of a mapping table storing vowel buttons corresponding to a user's fingers.

FIG. 6 illustrates an example of a method of inputting Korean based on a motion of a user's finger.

FIG. 7 is a block diagram of an electronic apparatus according to some embodiments of the present disclosure.

### MODE OF THE INVENTION

According to some embodiments of the present disclosure, a method of inputting Korean, performed by using an electronic apparatus includes displaying consonant buttons for inputting Korean consonants on a screen of the electronic apparatus; identifying a user's fingers; as a motion of a first finger is sensed among the user's fingers, selecting a consonant button corresponding to a location of the first finger; as the consonant button is selected, displaying vowel buttons corresponding to second, third, and fourth fingers among the user's fingers and being used to input Korean vowels on the screen of the electronic apparatus; and as a motion of at least one finger of the second, third, and fourth fingers is sensed, selecting at least one vowel button corresponding to the at least one finger.

The first finger is an index finger among the user's fingers, and the second, third, and fourth fingers are respectively middle, ring, and little fingers among the user's fingers.

The identifying of the user's fingers includes capturing images of the user's fingers; and identifying types of the user's fingers in the captured images.

The method may further include: tracking a location of the first finger; and displaying a cursor based on a location of the tracked first finger.

The selecting of the consonant button includes: sensing a motion that bends the first finger; and selecting the consonant button corresponding to a region that displays the cursor as the motion is sensed.

Also, the vowel buttons may include a “ [symbol] ” button, a “·” button, and a “ [symbol] ” button in order to input vowels by using a “cheon-ji-in” ( [symbol] , ·, [symbol] ) input method (“cheon,” “ji,” and “in” literally mean heaven, earth, and man, respectively).

The selecting of the at least one vowel button includes: sensing a motion that bends at least one finger of the second, third, and fourth fingers; and selecting at least one vowel button corresponding to the at least one finger.

The method may further include: as the consonant button is selected, displaying a button for inputting one of a space, a backspace, and a double consonant and corresponding to a fifth finger among the user's fingers.

Also, a fifth finger may be a thumb among the user's fingers.

As the consonant button is selected, vowel buttons corresponding to the second, third, and fourth fingers and a button corresponding to the fifth finger are displayed.

According to some embodiments of the present disclosure, an electronic apparatus includes a display configured to display consonant buttons for inputting Korean consonants on a screen of the electronic apparatus; and a controller configured to identify a user's fingers and, as a motion of a first finger is sensed among the user's fingers, select a consonant button corresponding to a location of the first finger, wherein, as the consonant button is selected, the display displays vowel buttons corresponding to second, third, and fourth fingers among the user's fingers and being used to input Korean vowels on the screen of the electronic apparatus; and wherein, as a motion of at least one finger of the second, third, and fourth fingers is sensed, the controller selects at least one vowel button corresponding to the at least one finger.

The first finger may be an index finger among the user's fingers, and the second, third, and fourth fingers may be respectively middle, ring, and little fingers among the user's fingers.

The electronic apparatus may further include: a user input interface configured to capture images of the user's fingers, wherein the controller identifies types of the user's fingers in the captured images.

The controller tracks a location of the first finger, and the display displays a cursor based on a location of the tracked first finger.

The controller senses a motion that bends the first finger and selects the consonant button corresponding to a region that displays the cursor as the motion is sensed.

Also, the vowel buttons may include a “ [symbol] ” button, a “·” button, and a “ [symbol] ” button in order to input vowels by using a “cheon-ji-in” ( [symbol] , ·, [symbol] ) input method.

The controller senses a motion that bends at least one finger of the second, third, and fourth fingers, and selects at least one vowel button corresponding to the at least one finger.

The display displays a button for inputting one of a space, a backspace, and a double consonant and corresponding to a fifth finger among the user's fingers.

As the consonant button is selected, the display may display vowel buttons corresponding to the second, third, and fourth fingers and a button corresponding to the fifth finger.

Terminologies used in the present specification will be briefly described, and then a detailed description of the present disclosure will be given.

With respect to the terms in the various embodiments of the present disclosure, general terms which are currently and widely used are selected in consideration of functions of structural elements in the various embodiments of the present disclosure. However, meanings of the terms may be changed according to intention, a judicial precedent, appearance of new technology, and the like. In addition, in certain cases, a term which is not commonly used may be selected. In such a case, the meaning of the term will be described in detail at the corresponding part in the description of the present disclosure. Therefore, the terms used in the various embodiments of the present disclosure should be defined based on the meanings of the terms and the descriptions provided herein.

In addition, unless explicitly described to the contrary, the word “include” and variations such as “includes” or “comprising” will be understood to imply the inclusion of stated elements but not the exclusion of any other elements. In addition, the term “units” described in the specification mean units for processing at least one function and operation and may be implemented by software components or hardware components.

Throughout the specification, “motion” may be an operation for selecting a button displayed on a screen of an electronic apparatus at a distance spaced apart from the electronic apparatus by moving each of user's fingers within a predetermined space.

While such terms as “first,” “second,” etc., may be used to describe various components, such components must not be limited to the above terms. The above terms are used only to distinguish one component from another. For example, a first component discussed below could be termed as a second component without departing from the teachings of the present disclosure and similarly the second component could be termed as the first component.

The present disclosure will now be described more fully with reference to the accompanying drawings, in which embodiments of the present disclosure are shown. The present disclosure may be implemented in various different forms and is not limited to the embodiments described herein. In the description of the present disclosure, certain detailed explanations of related art are omitted when it is deemed that they may unnecessarily obscure the essence of the present disclosure. Like reference numerals refer to like elements throughout

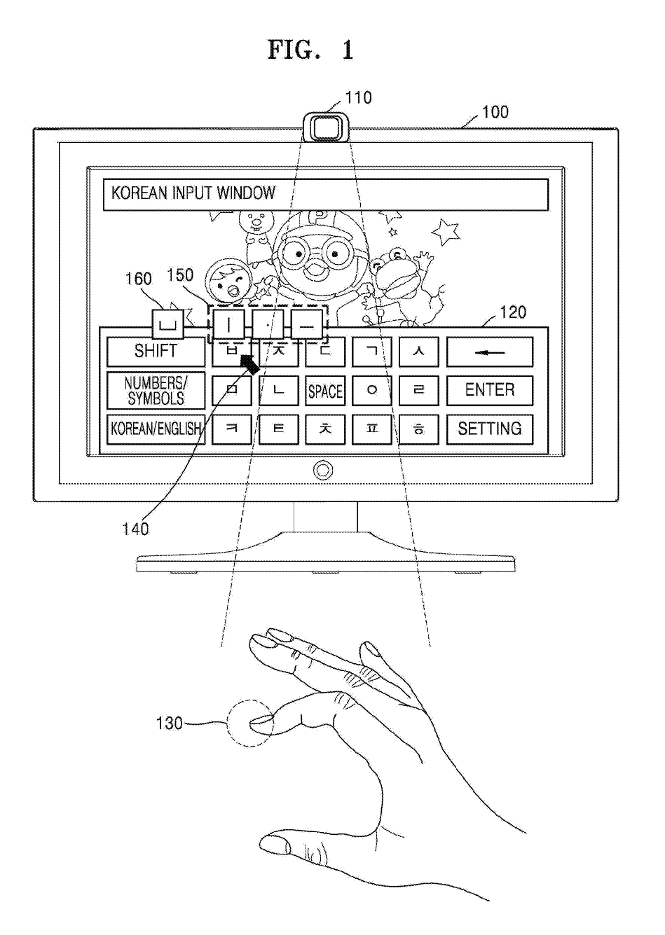

FIG. 1 is a schematic diagram for explaining a method of inputting Korean by using an electronic apparatus 100, according to some embodiments of the present application.

As shown in FIG. 1, the electronic apparatus 100 according to some embodiments of the present application may input Korean text (characters) based on motions of a user's fingers.

According to some embodiments, the electronic apparatus 100 may display consonant buttons 120 (for example, a “ [symbol] ” button or a “ [symbol] ” button, etc.) for inputting Korean consonants on a screen when the electronic apparatus 100 needs to input Korean (for example, a search formula is input from a user in a search application). In this case, a camera 110 may be in an available state.

According to some embodiments, the camera 110 may capture images of a user's hands and fingers. Also, the electronic apparatus 100 may identify types of the user's fingers located within a predetermined distance from the electronic apparatus 100 based on the captured images.

Also, the electronic apparatus 100 may track a user's index finger. In this regard, tracking may be a job in which the electronic apparatus 100 tracks a predetermined object and converts the tracked object into coordinate data of a screen. Also, the electronic apparatus 100 may display a cursor 140 on the screen based on a location of the tracked index finger. Also, the electronic apparatus 100 may sense a motion of the user's index finger. The electronic apparatus 100 may select one of the displayed consonant buttons 120 as the motion of the index finger is sensed.

For example, as the electronic apparatus 100 senses a motion 130 of the user's finger that bends the user's index finger, the electronic apparatus 100 may select a consonant button (for example, a “ [symbol] ” button) corresponding to a location of the cursor 140.

Thereafter, as the electronic apparatus 100 selects the consonant button, the electronic apparatus 100 may display vowel buttons 150 for inputting Korean vowels. Also, the electronic apparatus 100 may display a space (V) button 160 and the vowel buttons 150 for inputting a space (V).

Also, as the electronic apparatus 100 senses motions of the user's middle finger, ring finger, little finger, and thumb, the electronic apparatus 100 may select the vowel buttons 150 corresponding to the respective fingers.

For example, as the electronic apparatus 100 senses motions of the user's fingers that sequentially bend the ring finger and the little finger, the electronic apparatus 100 may select a “·” button corresponding to the ring finger and a button “-” corresponding to the little finger. In this case, the electronic apparatus 100 may combine “·” and “-” corresponding to the selected buttons to complete a Korean vowel “ [symbol] ”.

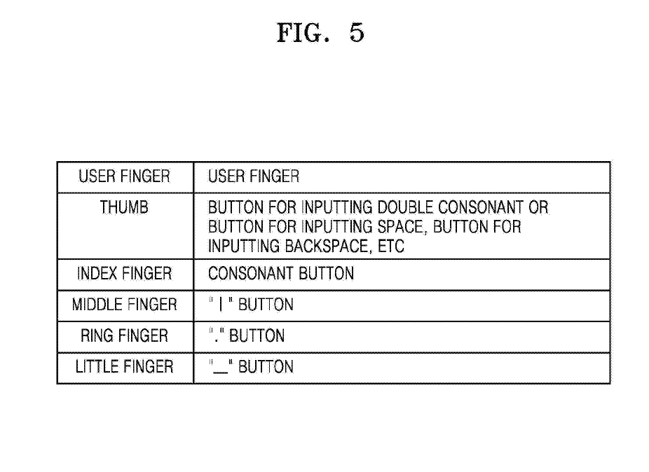

According to some embodiments, the electronic apparatus 100 may obtain a mapping table including information about buttons corresponding to the user's fingers. The mapping table will be described with reference to FIG. 5 below.

The electronic apparatus 100 may repeat the method described above, thereby selecting buttons for inputting initial consonants, medial vowels, and final consonants of Korean.

Meanwhile, according to some embodiments, the electronic apparatus 100 may include a television (TV), a Hybrid Broadcast Broadband TV (HBBTV), a smart TV, an Internet Protocol TV (IPTV), a smart phone, a tablet phone, a cellular phone, a personal digital assistant (PDA), a laptop, a media player, and a global positioning system (GPS) but is not limited thereto. The electronic apparatus 100 may include various apparatuses for inputting Korean.

Also, the camera 110 may include a depth camera, an infrared camera, etc. but is not limited thereto. The camera 100 may include various apparatuses for capturing images. The camera 110 may be included in the electronic apparatus 100 and may be independently present. When the camera 100 is independently present, an image captured by the camera 110 may be transmitted to the electronic apparatus 100 over a wired or wireless network.

The electronic apparatus 100 according to an embodiment of the present disclosure may sense motions of the user's fingers corresponding to respective vowel buttons to input Korean as the electronic apparatus 100 selects consonant buttons. Thus, the user does not need to move the cursor 140 in order to select a vowel button, thereby quickly inputting Korean.

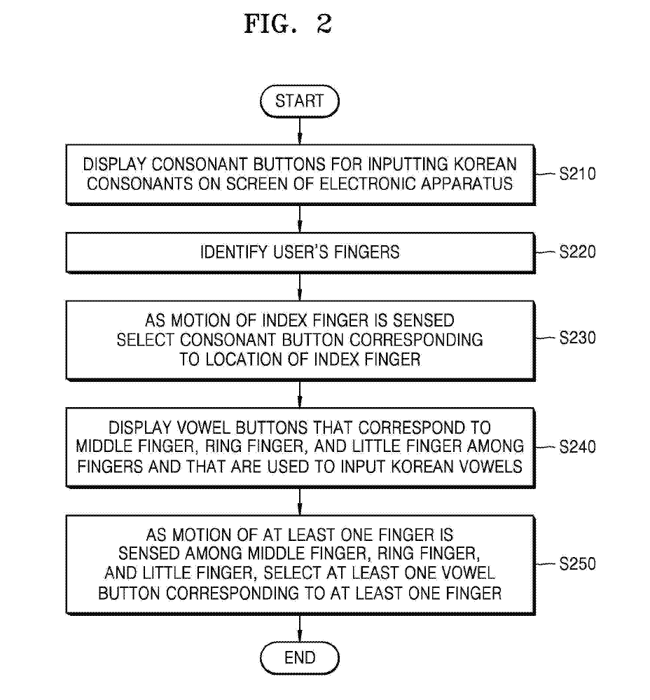

FIG. 2 is a diagram for explaining a method of inputting Korean according to an embodiment of the present disclosure.

Referring to FIG. 2, in operation S210, the electronic apparatus 100 may display consonant buttons for inputting Korean consonants.

According to an embodiment, the consonant buttons may include 14 consonant buttons for inputting Korean single consonants. Also, the consonant buttons may include 19 consonant buttons for inputting Korean double consonants and single consonants.

When the electronic apparatus 100 includes the 14 consonant buttons, the electronic apparatus 100 may select a double consonant corresponding to a consonant button based on a user input that selects a consonant button twice. Also, the electronic apparatus 100 may separately display a double consonant button for inputting the double consonant.

In operation S220, the electronic apparatus 100 may identify the user's fingers.

According to some embodiments, the electronic apparatus 100 may capture images of the user's fingers by using a camera located in front of the electronic apparatus 100. The electronic apparatus 100 may automatically place the camera in an available state when the electronic apparatus 100 needs to input Korean text (characters).

For example, the electronic apparatus 100 may display the consonant buttons and place the camera in the available state when a search window of a search application is executed.

Also, the electronic apparatus 100 may identify types of the user's fingers based on the captured images.

According to some embodiments, the electronic apparatus 100 may perform image processing on the captured images.

For example, the electronic apparatus 100 may identify the user's hands and fingers from the captured images based on machine learning, pattern recognition, computer vision algorithms, etc.

According to some embodiments, the electronic apparatus 100 may identify the user's thumb, index finger, middle finger, ring finger, and little finger through image processing on the captured images.

In operation S230, the electronic apparatus 100 may select a consonant button corresponding to a location of the index finger as the electronic apparatus 100 senses a motion of the user's index finger.

According to some embodiments, the electronic apparatus 100 may track the location of the index finger among the identified user's fingers. In this regard, tracking may be a job in which the electronic apparatus 100 tracks a predetermined object and converts the tracked object into coordinate data of a screen.

Also, the electronic apparatus 100 may display a cursor on the screen according to the tracked location of the index finger.

Also, the electronic apparatus 100 may sense a motion of the user's finger that bends the tracked index finger.

According to some embodiments, the electronic apparatus 100 may sense a finger motion that bends the user's index finger based on an image captured by the camera. Also, the electronic apparatus 100 may select a consonant button (for example, a “ [symbol] ” button) overlapped with a cursor and displayed as the electronic apparatus 100 senses the finger motion.

Also, according to some embodiments, as the electronic apparatus 100 senses the finger motion that stops the user's index finger for a predetermined period of time (for example, 1 second), the electronic apparatus 100 may select the consonant button overlapped with the cursor and displayed.

Also, as the electronic apparatus 100 senses a finger motion that moves the user's index finger in a straight line toward the electronic apparatus 100, the electronic apparatus 100 may select the consonant button overlapped with the cursor and displayed.

According to some embodiments, the electronic apparatus 100 may inform a user that one of displayed consonant buttons is selected. For example, the electronic apparatus 100 may change a color of the selected consonant button and display the changed consonant button.

Also, the electronic apparatus 100 may display a consonant (for example, “ [symbol] ”) corresponding to the selected consonant button on the screen.

Meanwhile, it is described that the electronic apparatus 100 selects a consonant button based on a user's index finger but the embodiment is not limited thereto. The electronic apparatus 100 may select a consonant button based on another finger.

In operation S240, as the electronic apparatus 100 selects one consonant button, the electronic apparatus 100 may display vowel buttons that correspond to the middle finger, the ring finger, and the little finger among the user's fingers and are used to input Korean vowels.

According to some embodiments, the vowel buttons for inputting Korean vowels may include a “ [symbol] ” button, a “·” button, and a “ [symbol] ” button in order to input Korean vowels by using a “cheon-ji-in” ( [symbol] , ·, [symbol] ) input method.

Also, the electronic apparatus 100 may display a space (V) button corresponding to the user's thumb and for inputting a space along with the vowel buttons.

Also, the electronic apparatus 100 may display a button for inputting a double consonant or a back space instead of the space button.

According to some embodiments, as the electronic apparatus 100 selects one of displayed consonant buttons, the electronic apparatus 100 may display vowel buttons adjacent to the selected consonant button and the space button.

Also, as the electronic apparatus 100 selects one of displayed consonant buttons, the electronic apparatus 100 may display the vowel buttons on a predetermined location of the screen. For example, the electronic apparatus 100 may display the vowel buttons on a top end or a bottom end of the screen.

Also, the electronic apparatus 100 may display an image of a user′ hand and buttons corresponding to respective fingers in order to intuitively display the buttons corresponding to the respective fingers.

Also, the electronic apparatus 100 may determine a display order of the vowel buttons and the space button according to a shape of the user's hand.

For example, when the user inputs Korean using his or her right hand, the electronic apparatus 100 may sequentially display the “·” button, the “ [symbol] ” button, the “·” button, and the “-” button respectively corresponding to the user's thumb, index finger, middle finger, ring finger, and little finger from a left screen. Meanwhile, when the user inputs Korean using his or her left hand, the electronic apparatus 100 may sequentially display the “·” button, the “ [symbol] ” button, the “·” button, and the “-” button from a right screen.

According to some embodiments, the electronic apparatus 100 may obtain a mapping table including information about the fingers corresponding to the “ [symbol] ” button, the “·” button, and the “-” button and the space button.

Also, the electronic apparatus 100 may change types of the displayed buttons by changing the mapping table. For example, the electronic apparatus 100 may display the backspace button instead of the space button as the space button of the mapping table is changed to the backspace button.

Also, the electronic apparatus 100 may change the user's fingers corresponding to the respective buttons by changing the mapping table.

According to some embodiments, the electronic apparatus 100 may receive a user input for changing the mapping table.

For example, the electronic apparatus 100 may receive a user input for changing the space button corresponding to the thumb to the “ [symbol] ” button. The electronic apparatus 100 may change the mapping table based on the user input.

Also, the electronic apparatus 100 may receive a user input for changing locations of displayed buttons.

In operation S250, as the electronic apparatus 100 senses a motion of at least one finger among the user's middle finger, ring finger, and little finger, the electronic apparatus 100 may select at least one vowel button corresponding to the at least one finger.

According to some embodiments, the electronic apparatus 100 may sense motions of the user's middle finger, ring finger, and little finger based on images obtained from the camera.

According to some embodiments, the electronic apparatus 100 may sense a finger motion that bends at least one finger among the middle finger, the ring finger, and the little finger.

Also, according to some embodiments, the electronic apparatus 100 may sense a finger motion that shakes at least one finger up and down within a predetermined space among the user's middle finger, the ring finger, and the little finger.

According to some embodiments, as the electronic apparatus 100 senses the finger motion, the electronic apparatus 100 may select at least one vowel button corresponding to the at least one finger.

For example, when the electronic apparatus 100 senses a finger motion that bends the middle finger, the electronic apparatus 100 may select the “ [symbol] ” button corresponding to the middle finger.

Also, as the electronic apparatus 100 senses finger motions that bend the middle finger and the ring finger, the electronic apparatus 100 may select the “ [symbol] ” button and the “·” button respectively corresponding to the middle finger and the little finger. In this case, the electronic apparatus 100 may combine “·” and “-” corresponding to the “ [symbol] ” button and the “·” button to complete a Korean vowel “ [symbol] ”.

Also, the electronic apparatus 100 may inform the user that the at least one vowel button is selected.

For example, the electronic apparatus 100 may change a color of the selected vowel button and display the changed vowel button. Also, the electronic apparatus 100 may display a vowel (for example, “ [symbol] ”) corresponding to the selected vowel button.

Also, the electronic apparatus 100 may selectively repeat operations S230 through S250, thereby selecting a final consonant of Korean text (character) and selecting new Korean text.

For example, the electronic apparatus 100 may track a user's index finger and sense a finger motion that bends the user's index finger, thereby selecting a new consonant button (for example, a “ [symbol] ” button).

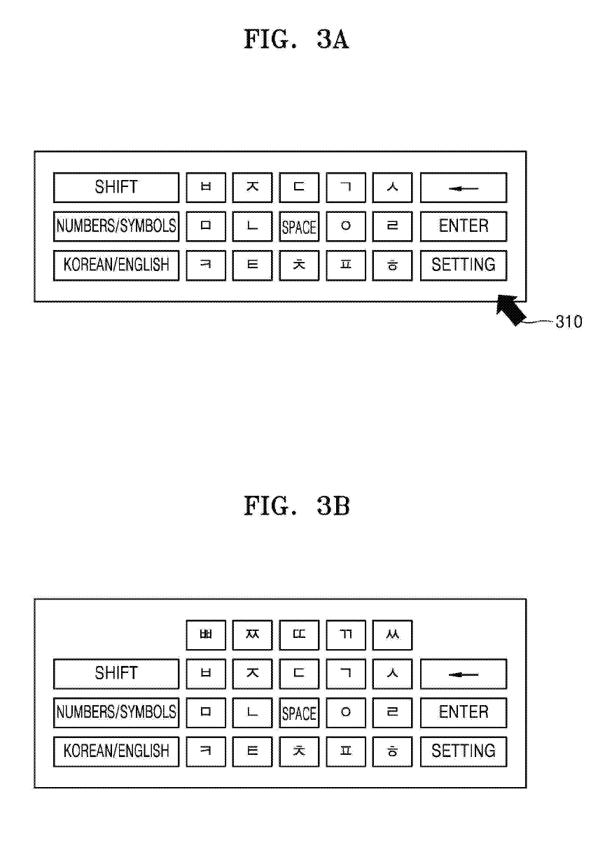

FIGS. 3A and 3B illustrate examples in which the electronic apparatus 100 displays consonant buttons for inputting Korean consonants.

Referring to FIG. 3A, the electronic apparatus 100 according to some embodiments of the present disclosure may display 14 consonant buttons (for example, a “ [symbol] ” button, a “ [symbol] ” button, etc.) for inputting Korean single consonants in order to input Korean consonants.

According to some embodiments, the electronic apparatus 100 may sense a motion of a user's finger that selects some consonant buttons (for example, a “ [symbol] ” button, a “ [symbol] ” button, a “ [symbol] ” button, a “ [symbol] ” button, and a “ [symbol] ” button) from the consonant buttons twice, thereby selecting Korean double consonants (for example, “ [symbol] ”, “ [symbol] ”, “ [symbol] ”, “ [symbol] ”, and “ [symbol] ”).

For example, the electronic apparatus 100 may sense a finger motion that bends an index finger twice, thereby selecting the “ [symbol] ” consonant button twice. In this case, the electronic apparatus 100 may select a double consonant (for example, “ [symbol] ”) corresponding to the “ [symbol] ” button.

Also, as the electronic apparatus 100 selects the consonant button, the electronic apparatus 100 may display a button for inputting a double consonant corresponding to the selected consonant button along with vowel buttons but is not limited thereto. For example, the electronic apparatus 100 may sense a motion of a user's finger that selects a consonant button along with a shift button, thereby selecting the double consonant corresponding to the selected consonant button.

Also, referring to FIG. 3B, the electronic apparatus 100 according to some embodiments of the present disclosure may display 19 consonant buttons for inputting Korean single consonants and double consonants in order to input Korean consonants.

Also, as shown in FIGS. 3A and 3B, the electronic apparatus 100 may display non-text buttons for inputting non-text. For example, the electronic apparatus 100 may display non-text buttons for inputting shift, space, backspace, a number/symbol conversion function, a Korean/English conversion function and setting, etc.

Also, the electronic apparatus 100 may display a button (not shown) for inputting the Korean/English conversion function but is not limited thereto. For example, the electronic apparatus 100 may display buttons for inputting Tab, Control (Ctrl), etc.

Also, the electronic apparatus 100 may display buttons for performing a predetermined function of an application that is being executed therein.

According to some embodiments, the electronic apparatus 100 may track the user's index finger. The electronic apparatus 100 may display a cursor 310 according to a change in a location of the tracked index finger.

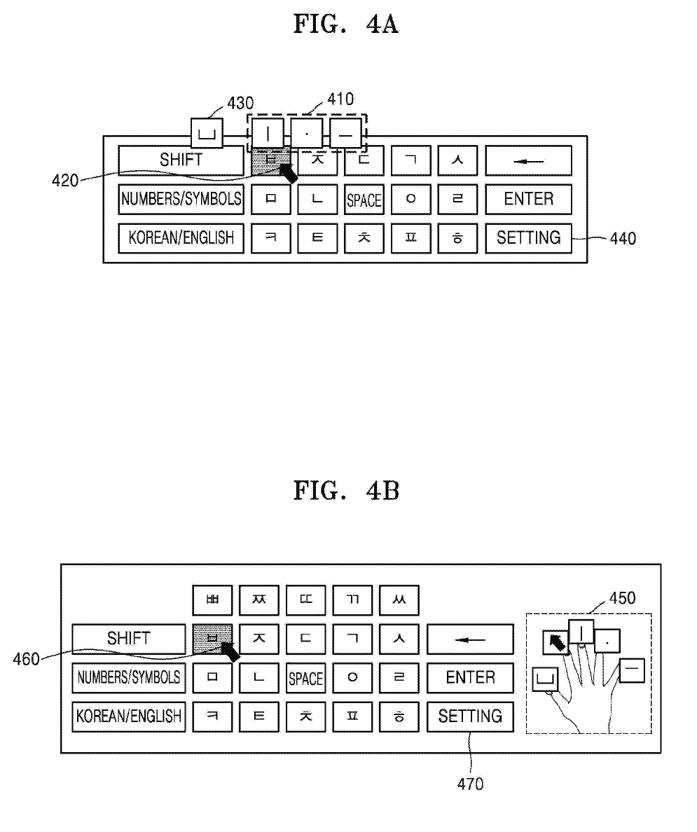

FIGS. 4A and 4B illustrate examples in which the electronic apparatus 100 displays Korean vowel buttons for inputting Korean.

Referring to FIGS. 4A and 4B, as the electronic apparatus 100 according to some embodiments of the present disclosure selects a consonant button, the electronic apparatus 100 may display vowel buttons 410 for inputting vowels.

The vowel buttons 410 may include a “ [symbol] ” button, a “·” button, and a “-” button in order to input [symbol] , ·, - (“cheon-ji-in”).

As shown in FIG. 4A, as the electronic apparatus 100 selects a consonant button, the electronic apparatus 100 may display the vowel buttons 410 on a location adjacent to the selected consonant button.

Also, as the electronic apparatus 100 selects the consonant button, the electronic apparatus 100 may display a space (V) button 430 for inputting a space along with the vowel buttons 410.

According to some embodiments, the electronic apparatus 100 may correspond user's middle finger, ring finger, and little finger respectively to a “ [symbol] ” button, a “·” button, and a “-” button.

For example, as the electronic apparatus 100 senses a finger motion that bends the user's middle finger, the electronic apparatus 100 may select the “ [symbol] ” button corresponding to the middle finger.

Also, as the electronic apparatus 100 sequentially senses finger motions that bend the user's little finger and middle finger, the electronic apparatus 100 may sequentially select the “-” button and the “ [symbol] ” button respectively corresponding to the little finger and the middle finger.

Also, according to some embodiments, as shown in FIG. 4B, as the electronic apparatus 100 selects the consonant button, the electronic apparatus 100 may display an image 450 of vowel buttons along with an image of a user's hand on a predetermined location of a screen.

For example, the electronic apparatus 100 may display the image 450 of the “ [symbol] ” button, the “·” button, and the “-” button respectively corresponding to fingers of a user's right hand along with an image of the user's right hand. If the user inputs Korean with a user's left hand, a displayed image may be an image of the left hand.

According to some embodiments, the electronic apparatus 100 may display a setting window in response to motions of user's fingers that select “setting” buttons 440 and 470 displayed on the screen.

Also, the electronic apparatus 100 may change locations on which the images 410 and 450 of vowel buttons are displayed and types of other displayed buttons based on a user input received in the setting window.

For example, the electronic apparatus 100 may change the “ [symbol] ” button corresponding to the index finger to the “·” button according to the user input received in the setting window.

FIG. 5 is a table showing an example of a mapping table storing vowel buttons corresponding to user's fingers.

Referring to FIG. 5, the electronic apparatus 100 according to some embodiments of the present disclosure may obtain the mapping table including information about buttons corresponding to user's fingers.

As shown in FIG. 5, a user's thumb may be mapped to at least one button among a double consonant button for inputting a double consonant (for example, one of “ [symbol] ”, “ [symbol] ”, “ [symbol] ”, “ [symbol] ”, and “ [symbol] ”), a space (V) button for inputting a space, and a backspace (<-) button for inputting a backspace.

Also, a user's middle finger may be mapped to a “ [symbol] ” button, a user' ring finger may be mapped to a “·” button, and a user's little finger may be mapped to a “-” button.

Also, a user's index finger may correspond to a location of a cursor on a screen and may be mapped to a finger that selects a consonant button, etc.

According to some embodiments, the electronic apparatus 100 may change fingers corresponding to respective buttons based on a user input received in a setting window.

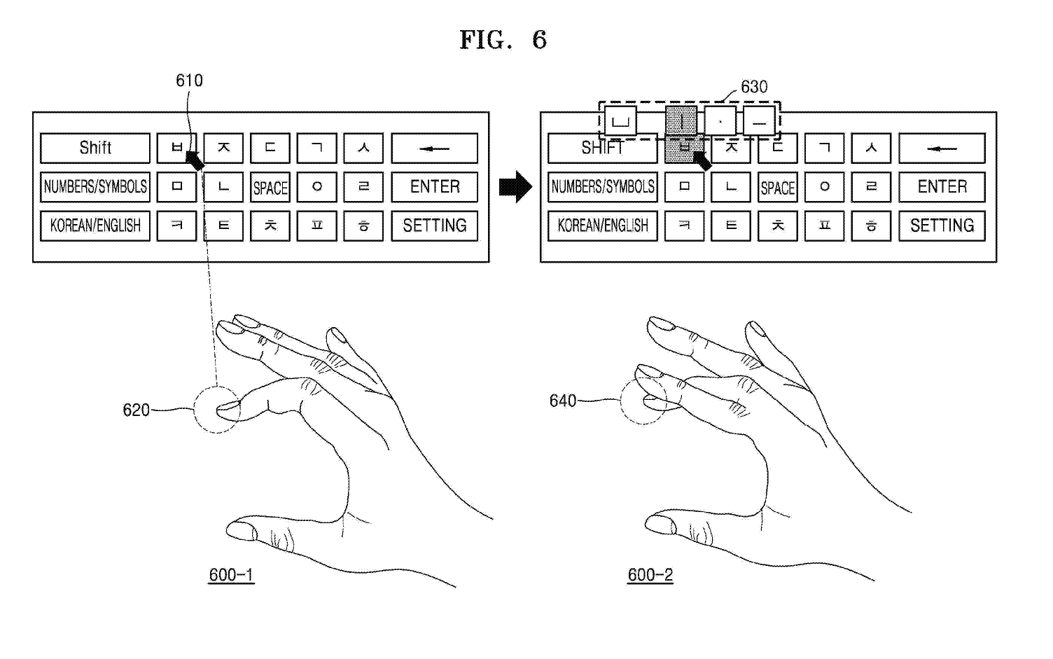

FIG. 6 illustrates an example of a method of inputting Korean based on a finger motion.

Referring to FIG. 600-1 of FIG. 6, the electronic apparatus 100 may identify user's hand and fingers based on an image captured by a camera.

Also, the electronic apparatus 100 may track an index finger among the user's fingers. In this regard, tracking may be a job in which the electronic apparatus 100 tracks a location of a predetermined object and converts the tracked location into coordinate data of a screen.

Also, the electronic apparatus 100 may display a cursor 610 based on a location of the tracked index finger.

Also, the electronic apparatus 100 may select a consonant button as the electronic apparatus 100 senses a first finger motion 620 of a user that bends the index finger.

For example, the electronic apparatus 100 may select a “ [symbol] ” button overlapped with the cursor 610 and displayed as the electronic apparatus 100 senses the first finger motion 620.

Also, the electronic apparatus 100 may display vowel buttons and a space (V) button 630 on a location of the screen adjacent to the “ [symbol] ” button as the electronic apparatus 100 selects the “ [symbol] ” button.

Also, referring to 600-2, as the electronic apparatus 100 senses a second finger motion 640 that bends a user's middle finger, the electronic apparatus 100 may select a “ [symbol] ” button corresponding to the user's middle finger among the vowel buttons.

Also, as the electronic apparatus 100 senses motions that bend user's little finger and ring finger, the electronic apparatus 100 may select the “ [symbol] ” button and the “·” button respectively corresponding to the little finger and ring finger.

Meanwhile, the second finger motion 640 may be a finger motion that shakes the user's middle finger left and right within a predetermined space and may be a finger motion that shakes the user's middle finger up and down within a predetermined space.

Also, the electronic apparatus 100 may display Korean “ [symbol] [symbol] ” corresponding to the selected consonant button and vowel button.

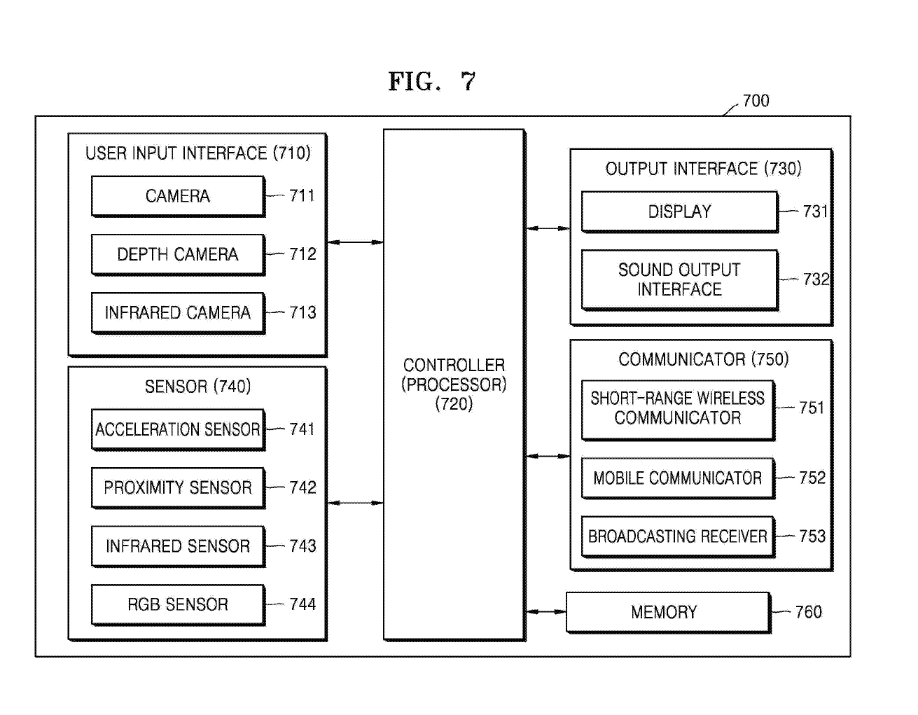

FIG. 7 is a block diagram of an electronic apparatus 700 according to some embodiments of the present disclosure.

As shown in FIG. 7, the electronic apparatus 700 according to some embodiments of the present disclosure may include a user input interface 710, a controller 720, and an output interface 730. However, all of the illustrated components are not essential. The electronic apparatus 700 may be implemented by more components than those illustrated in FIG. 7 or less components than those illustrated in FIG. 7.

For example, the electronic apparatus 700 according to some embodiments of the present disclosure may include a sensor 740, a communicator 750, and a memory 760, in addition to the user input interface 710, the controller 720, and the output interface 730.

The components will be described below.

According to some embodiments, the user input interface 710 may include a camera 711, a depth camera 712, an infrared camera 713, etc. that are located in front of the electronic apparatus 700.

According to some embodiments, the camera 711 may obtain an image frame such as a still image or a moving image including a user's hand and fingers though an image sensor. An image captured through the image sensor may be transmitted to the controller 720 or a separate image processor (not shown).

Also, the user input interface 710 may include various sensors for sensing motions of the user's fingers. For example, the user input interface 710 may sense the motions of the fingers through an infrared sensor, etc.

The output interface 730 may be used to output an audio signal or a video signal and may include a display 731 and a sound output interface 732, etc.

The display 731 may display information processed by the electronic apparatus 700.

According to some embodiments, the display 731 may display a cursor on a screen based on a location of a user's index finger.

Also, the display 731 may display consonant buttons for inputting Korean consonants. Also, the display 731 may display non-text buttons for inputting non-text (shift, space, backspace, a number/symbol conversion function, Korean/English conversion function and setting, etc.) along with the consonant buttons.

Also, the display 731 may display buttons for performing a predetermined function of an application that is being executed in the electronic apparatus 700.

Also, the display 731 may display vowel buttons for inputting Korean vowels according to a control signal received from the controller 720.

According to some embodiments, the display 731 may display a “ [symbol] ” button, a “·” button, and a “-” button in order to input Korean vowels by using a “cheon-ji-in” ( [symbol] , ·, -) input method.

Also, the display 731 may display at least one button among a space (V) button for inputting a space, a double consonant button for inputting a double consonant, and a backspace button for inputting a backspace along with vowel buttons.

The controller 720 may generally control a general operation of the electronic apparatus 700. For example, the controller 720 may generally control the user input interface 710, the output interface 730, etc.

According to some embodiments, the controller 720 may receive images of user's hand and fingers captured by the user input interface 710.

Also, the controller 720 may perform image processing on the received images. For example, the electronic apparatus 100 may identify types of the user's fingers from the received images based on machine learning, pattern recognition, computer vision algorithm, etc. Also, the controller 720 may identify a shape of the user's hand from the received image.

Also, the controller 720 may track a location of an index finger among the identified user's fingers.

Also, the controller 720 may transmit a control signal for displaying a cursor on a screen to the output interface 730 according to the tracked location of the index finger. In this case, the control signal may include coordinate information about the cursor on the screen.

Also, the controller 720 may sense motions of the user's fingers based on the received images of the user's fingers. For example, the controller 720 may sense motions that bend the fingers.

Also, the controller 720 may select a consonant button overlapped with the cursor and displayed as the controller 720 senses a motion of the user's index finger. Also, as the controller 720 selects the consonant button, the controller 720 may transmit a control signal to the output interface 730 to display vowel buttons for inputting Korean vowels. In this case, the control signal may include coordinate information on a screen that displays the vowel buttons.

Also, the controller 720 may obtain a mapping table including information about buttons corresponding to the fingers from the memory 760.

Also, the controller 720 may sense a motion of a user's finger that bends at least one of user's middle finger, ring finger, and little finger. The controller 720 may select at least one vowel button corresponding to the at least one finger based on the mapping table.

For example, the controller 720 may select the [symbol] ” button and the “·” button as the controller 720 senses motions that bend the middle finger and the ring finger.

Also, the controller 720 may determine a sequence of the displayed vowel buttons and space button according to the identified shape of the user's hand.

For example, when the identified shape of the user's hand is a right hand, the controller 720 may transmit a control signal to the output interface 730 to display buttons respectively corresponding to user's thumb, middle finger, ring finger, and little finger from a left of the screen.

The sensor 740 may include at least one of an acceleration sensor 741, a proximity sensor 742, an infrared sensor 743, and an RGB sensor 744 but is not limited thereto. Functions of the 741, the proximity sensor 742, the infrared sensor 743, and the RGB sensor 744 can be intuitively understood by one of ordinary skill in the art in view of their names, and thus detailed descriptions thereof will be omitted herein.

The communicator 750 may include one or more components that enable the electronic apparatus 700 and an external apparatus to communicate with each other. For example, the communicator 750 may include a short-range wireless communicator 751, a mobile communicator 752, and a broadcasting receiver 753.

The short-range wireless communicator 751 may include, but is not limited to, a Bluetooth communicator, a Bluetooth Low Energy (BLE) communicator, a near field communicator (NFC), a wireless local area network (WLAN) (e.g., Wi-Fi) communicator, a ZigBee communicator, an infrared Data Association (IrDA) communicator, a Wi-Fi direct (WFD) communicator, an ultra wideband (UWB) communicator, an Ant+ communicator, and the like.

The mobile communicator 752 may exchange a wireless signal with at least one selected from a base station, an external terminal, and a server on a mobile communication network. Examples of the wireless signal may include a voice call signal, a video call signal, and various types of data generated during a short message service (SMS)/multimedia messaging service (MMS).

The broadcasting receiver 753 may receive a broadcasting signal and/or broadcasting-related information from an external source via a broadcasting channel. The broadcasting channel may be a satellite channel, a ground wave channel, or the like. According to embodiments, the electronic apparatus 700 may not include the broadcasting receiver 753.

The memory 760 may store a program used by the controller 720 to perform processing and control, and may also store input/output data (for example, a plurality of menus, a plurality of first layer sub menus respectively corresponding to the plurality of menus, a plurality of second layer sub menus respectively corresponding to the plurality of first layer sub menus, etc.)

According to some embodiments, the memory 760 may store a mapping table including the information about the buttons corresponding to the user's fingers.

The memory 760 may include at least one type of storage medium selected from among a flash memory type, a hard disk type, a multimedia card micro type, a card type memory (for example, a secure digital (SD) or extreme digital (XD) memory), random access memory (RAM), a static random access memory (SRAM), read-only memory (ROM), electrically erasable programmable ROM (EEPROM), programmable ROM (PROM), magnetic memory, a magnetic disk, and an optical disk. The electronic apparatus 700 may operate a web storage or a cloud server on the internet which performs a storage function of the memory 760.

A method according to an embodiment of the present disclosure may be embodied as program commands executable by various computer means and may be recorded on a non-transitory computer-readable recording medium. The non-transitory computer-readable recording medium may have recorded thereon program commands, data files, data structures, and the like separately or in combinations. The program commands to be recorded on the non-transitory computer-readable recording medium may be specially designed and configured for embodiments of the present disclosure or may be well-known to and be usable by one of ordinary skill in the art of computer software. Examples of the non-transitory computer-readable recording medium include a magnetic medium such as a hard disk, a floppy disk, or a magnetic tape, an optical medium such as a compact disk-read-only memory (CD-ROM) or a digital versatile disk (DVD), a magneto-optical medium such as a floptical disk, and a hardware device specially configured to store and execute program commands such as a ROM, a random-access memory (RAM), or a flash memory. Examples of the program commands are advanced language codes that can be executed by a computer by using an interpreter or the like as well as machine language codes made by a compiler.

According to an embodiment of the present disclosure, the electronic apparatus 700 may not use a hardware text input apparatus for inputting Korean and may identify and track user's fingers by using a camera, thereby providing a system for inputting Korean based on motions of the user's fingers at a far distance.

While the present disclosure has been particularly shown and described with reference to exemplary embodiments thereof, various modifications and adaptations will be readily apparent to one of ordinary skill in the art without departing from the spirit and scope of the present disclosure.

1. A method of inputting Korean, performed by using an electronic apparatus, the method comprising:
displaying consonant buttons for inputting Korean consonants on a screen of the electronic apparatus;
identifying a user's fingers;
as a motion of a first finger is sensed among the user's fingers, selecting a consonant button corresponding to a location of the first finger;
as the consonant button is selected, displaying vowel buttons corresponding to second, third, and fourth fingers among the user's fingers and being used to input Korean vowels on the screen of the electronic apparatus; and
as a motion of at least one finger of the second, third, and fourth fingers is sensed, selecting at least one vowel button corresponding to the at least one finger.

2. The method of claim 1,
wherein the first finger is an index finger among the user's fingers, and
wherein the second, third, and fourth fingers are respectively middle, ring, and little fingers among the user's fingers.

3. The method of claim 1, wherein the identifying of the user's fingers comprises:
capturing images of the user's fingers; and
identifying types of the user's fingers in the captured images.

4. The method of claim 3, further comprising:
tracking a location of the first finger; and
displaying a cursor based on a location of the tracked first finger.

5. The method of claim 4, wherein the selecting of the consonant button comprises:
sensing a motion that bends the first finger; and
selecting the consonant button corresponding to a region that displays the cursor as the motion is sensed.

6. The method of claim 1, wherein the selecting of the at least one vowel button comprises:
sensing a motion that bends at least one finger of the second, third, and fourth fingers; and
selecting at least one vowel button corresponding to the at least one finger.

7. The method of claim 1, further comprising: as the consonant button is selected, displaying a button for inputting one of a space, a backspace, and a double consonant and corresponding to a fifth finger among the user's fingers.

8. The method of claim 7, wherein as the consonant button is selected, vowel buttons corresponding to the second, third, and fourth fingers and a button corresponding to the fifth finger are displayed.

9. An electronic apparatus comprising:
a display configured to display consonant buttons for inputting Korean consonants on a screen of the electronic apparatus; and
a controller configured to identify a user's fingers and, as a motion of a first finger is sensed among the user's fingers, select a consonant button corresponding to a location of the first finger,
wherein, as the consonant button is selected, the display displays vowel buttons corresponding to second, third, and fourth fingers among the user's fingers and being used to input Korean vowels on the screen of the electronic apparatus; and
wherein, as a motion of at least one finger of the second, third, and fourth fingers is sensed, the controller selects at least one vowel button corresponding to the at least one finger.

10. The electronic apparatus of claim 9, further comprising: a user input interface configured to capture images of the user's fingers,
wherein the controller identifies types of the user's fingers in the captured images.

11. The electronic apparatus of claim 9,
wherein the controller tracks a location of the first finger, and
wherein the display displays a cursor based on a location of the tracked first finger.

12. The electronic apparatus of claim 11, wherein the controller senses a motion that bends the first finger and selects the consonant button corresponding to a region that displays the cursor as the motion is sensed.

13. The electronic apparatus of claim 9, wherein the controller senses a motion that bends at least one finger of the second, third, and fourth fingers, and selects at least one vowel button corresponding to the at least one finger.

14. The electronic apparatus of claim 9, wherein the display displays a button for inputting one of a space, a backspace, and a double consonant and corresponding to a fifth finger among the user's fingers.

15. A non-transitory computer-readable recording medium having recorded thereon a program, which, when executed by a computer, performs the method of claim 1.
